(19) United States
(12) Patent Application Publication
(10) Pub. No.: US 2016/0201974 A1
(43) Pub. Date: Jul. 14, 2016

(54) REFRIGERATING DEVICE WITH A DOOR RACK

(71) Applicant: BSH HAUSGERÄTE GMBH, München (DE)

(72) Inventors: JOCHEN GRIMMINGER, TAPFHEIM (DE); STEPHAN KEMPFLE, ELLZEE (DE); HANS PETER WERNER, GIENGEN (DE); GERHARD WETZL, SONTHEIM (DE)

(73) Assignee: BSH Bosch Und Siemens Hausgerate GMBH, Munchen (DE)

(21) Appl. No.: 14/913,391

(22) PCT Filed: Aug. 13, 2014
(86) PCT No.: PCT/EP2014/067327

§ 371 Date: Feb. 22, 2016

(30) Foreign Application Priority Data
Aug. 23, 2013 (DE) 10 2013 216 769.5

(51) Int. Cl. F25D 23/02; G03B 17/56; G03B 17/02; G03B 29/00

(52) U.S. Cl. CPC F25D 23/028; G03B 29/00; G03B 17/561; G03B 17/02

(57) ABSTRACT

A refrigerating device includes a door rack and a camera housing support for positioning a camera module. The camera housing support is disposed adjacent the door rack. An outer surface of the camera housing support is at least partly flush with an outer surface of the door rack.

The present invention relates to a refrigerating device with a door rack and to a camera housing support for positioning a camera module, which is arranged adjacently to the door rack.

It is the object underlying the invention to specify a refrigerating device, in which an edge-free integration of a camera module is enabled.

This object is achieved by the subject matter having the features as claimed in the independent claim. Advantageous embodiments of the invention form the subject matter of the figures, the description and of the dependent claims.

According to one aspect of the invention, the object is achieved by a refrigerating device having a door rack and a camera housing support for positioning a camera module, which is arranged adjacently to the door rack, in which an outer surface of the camera housing support is at least partially flush with an outer surface of the door rack. As a result, the technical advantage is achieved for instance in that a flush assembly of the door rack and of the camera housing support can be realized, thereby producing an edge-free surface.

A refrigerating device is understood in particular to mean a domestic refrigerating device, in other words a refrigerating device which is used for housekeeping purposes in households or in the field of gastronomy, and in particular serves to store food and/or beverages at specific temperatures, like for instance a refrigerator, a freezer, a fridge-freezer, a chest freezer or a wine chiller.

In an advantageous embodiment of the refrigerating device, an outer surface formed by the door rack is continued by an outer surface of the camera housing support. As a result, the technical advantage is likewise achieved for instance in that an edge-free surface is produced.

In a further advantageous embodiment of the refrigerating device, the camera housing support is arranged in the side region of the door rack. As a result, the technical advantage is achieved for instance in that the camera housing support can be arranged flush with a front and a side wall of the door rack.

In a further advantageous embodiment of the refrigerating device, the camera housing support is arranged below the door rack. As a result, the technical advantage is achieved for instance in that the camera module in the interior of the camera housing support is not obstructed by the product to be cooled.

In a further advantageous embodiment of the refrigerating device, the camera housing support comprises a wall, the surface of which diagonally opposite to the door inner plate points into the interior of the refrigerating device. As a result, the technical advantage is achieved for instance in that the camera module can be arranged behind the wall so that the camera module can record a large field of view in the interior of the refrigerating device.

In a further advantageous embodiment of the refrigerating device, the door rack and the camera housing support has a shared contour line. As a result, the technical advantage is likewise achieved in that a flush outer surface is produced.

In a further advantageous embodiment of the refrigerating device, the door rack has a side wall, which runs diagonally to the door inner plate. As a result, the technical advantage is achieved for instance in that the space conditions in the interior of the refrigerating device are used effectively and the door rack is prevented from abutting against the inner container.

In a further advantageous embodiment of the refrigerating device, the camera housing support is fastened to the door rack or to a door inner plate. As a result, the technical advantage is achieved for instance in that the camera housing support can be fastened in a robust manner.

In a further advantageous embodiment of the refrigerating device, the camera housing support comprises an opening for the lateral attachment of an adjustment tray. As a result, the technical advantage is achieved for instance in that the camera housing support can be adjusted to the shape of various door racks.

In a further advantageous embodiment of the refrigerating device, the camera housing support is arranged adjacently to a door pillar. As a result, the technical advantage is achieved for instance in that a robust fastening of the door rack is achieved.

In a further advantageous embodiment of the refrigerating device, the camera housing support comprises an openable cover for assembling a camera housing module. As a result, the technical advantage is achieved for instance in that the camera module can be easily integrated and replaced.

In a further advantageous embodiment of the refrigerating device, the cover is rotatably fastened to the camera housing support. As a result, the technical advantage is achieved for instance in that the cover is undetachably affixed to the camera housing support.

In a further advantageous embodiment of the refrigerating device, the cover is oriented toward the center of a refrigerating device door. As a result, the technical advantage is achieved for instance in that the outer contour of the camera housing support is not negatively affected.

In a further advantageous embodiment of the refrigerating device, the camera housing support comprises a receiving facility for receiving a camera housing module. As a result, the technical advantage is achieved for instance in that a camera module encapsulated in the interior of the camera housing module can be used.

In a further advantageous embodiment of the refrigerating device, the camera housing support has a shared contour line with the door rack. As a result, the technical advantage is achieved for instance in that the camera housing support does not protrude beyond the door rack.

In a further advantageous embodiment of the refrigerating device, the receiving facility comprises guide rails for inserting the camera housing module. As a result, the technical advantage is achieved for instance in that the camera housing module can be easily inserted.

In a further advantageous embodiment of the refrigerating device, the camera housing support is formed from transparent plastic. As a result, the technical advantage is achieved for instance in that a separate window for the camera module can be omitted.

Exemplary embodiments of the invention are shown in the drawings, and are described in more detail below, in which;

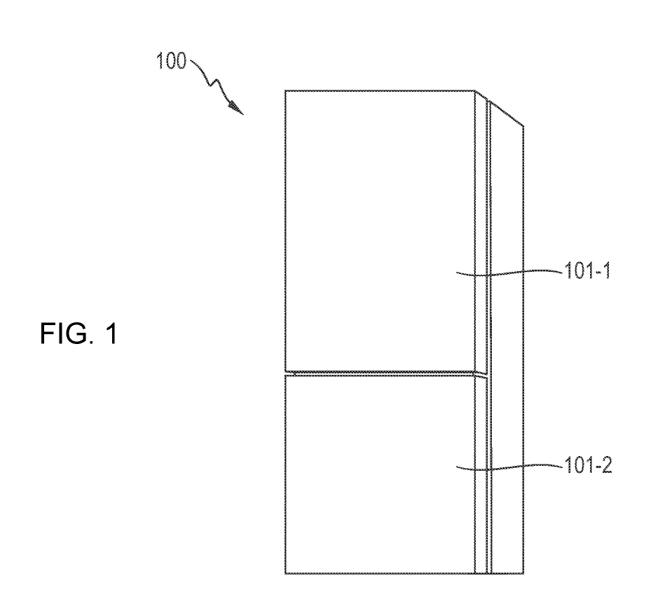

FIG. 1 shows a schematic view of a refrigerating device, and

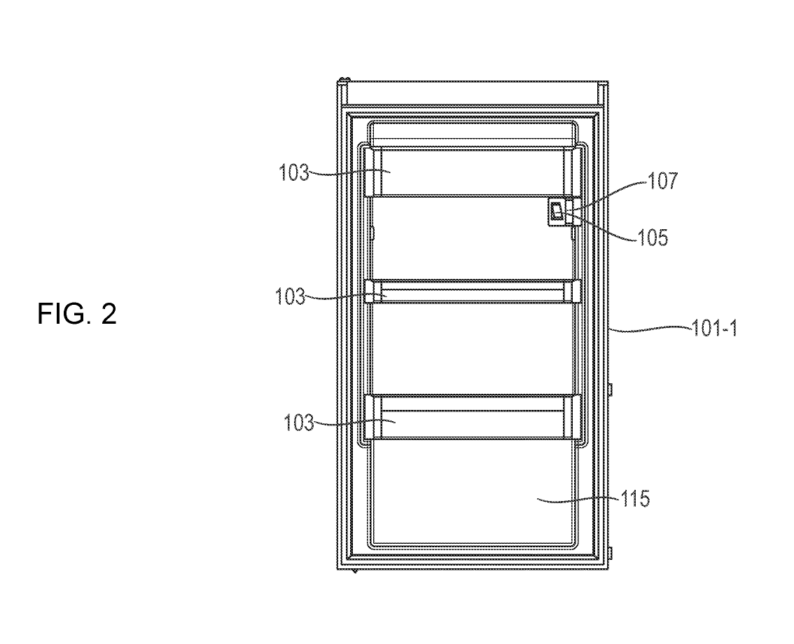

FIG. 2 shows a view of a door inner plate with door racks and a camera housing support;

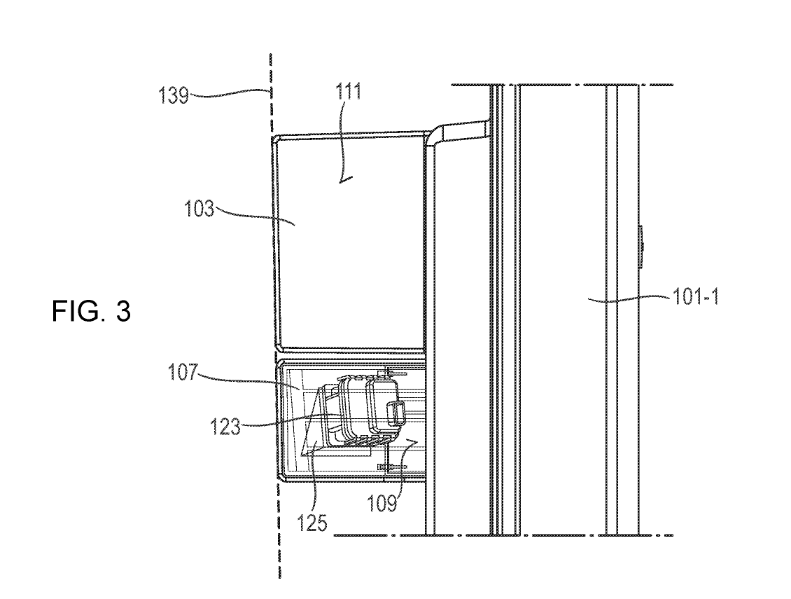

FIG. 3 shows a side view of a refrigerating device door with a door rack and a camera housing support;

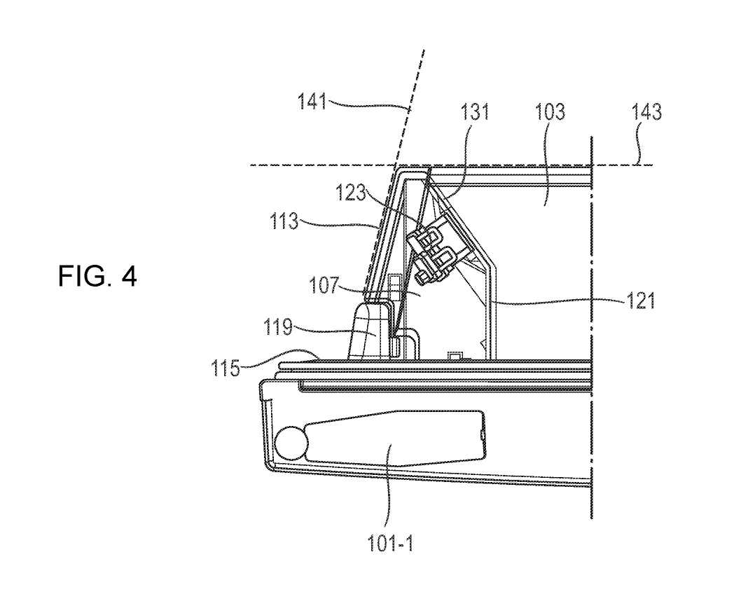

FIG. 4 shows a view of a refrigerating device door with a door rack and a camera housing support;

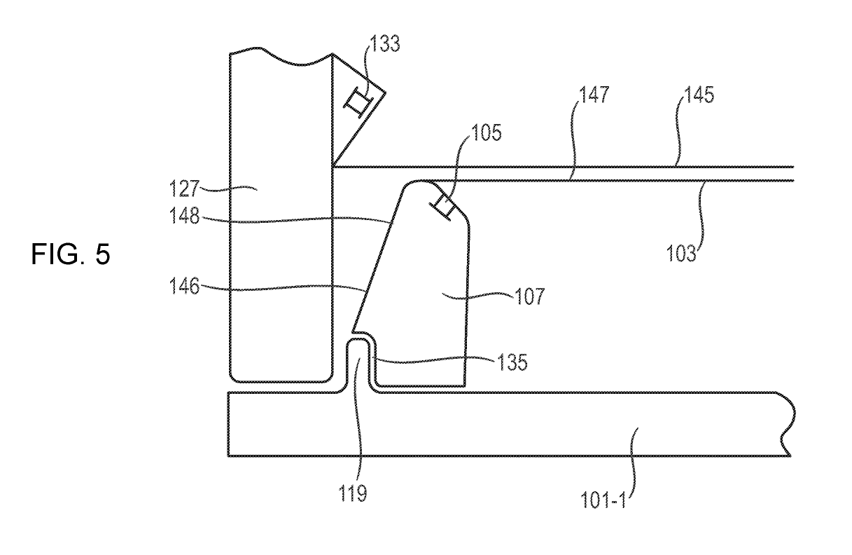

FIG. 5 shows a schematic view of a refrigerating device door with a door rack and a camera housing support;

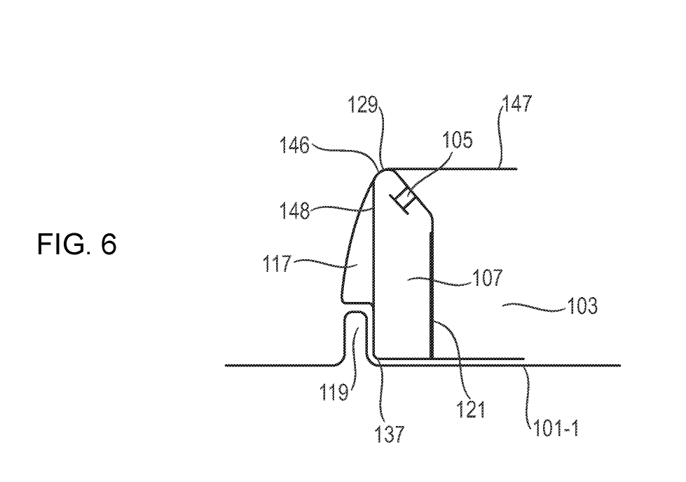

FIG. 6 shows a schematic view of a refrigerating device door with a door rack and a camera housing support;

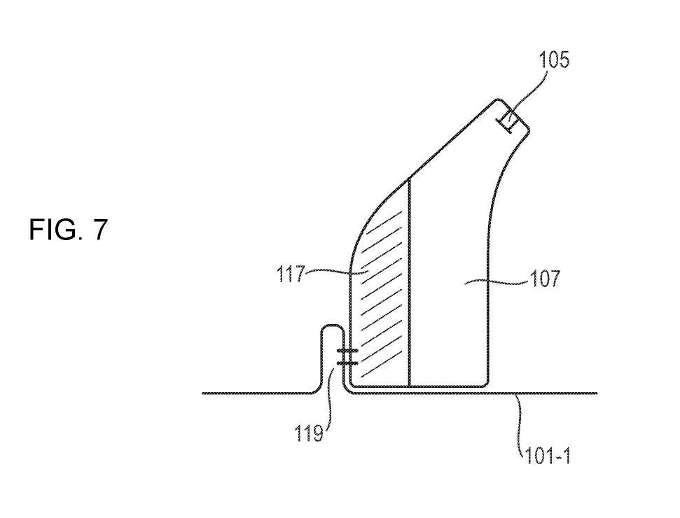

FIG. 7 shows a schematic view of a refrigerating device door with a door rack and a camera housing support;

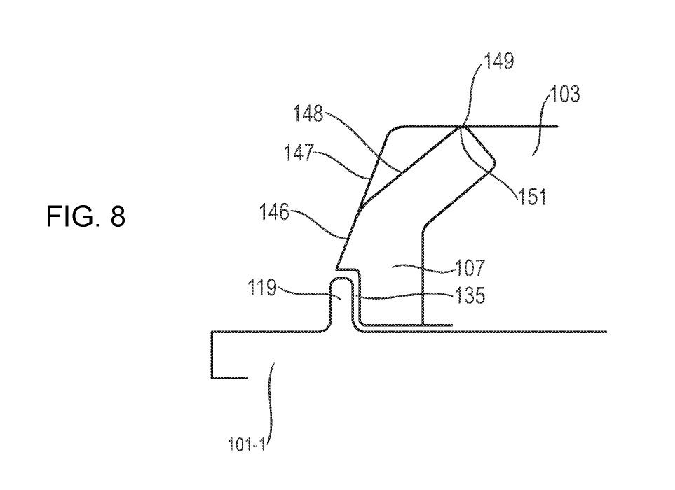

FIG. 8 shows a schematic view of a refrigerating device door with a door rack and a camera housing support; and

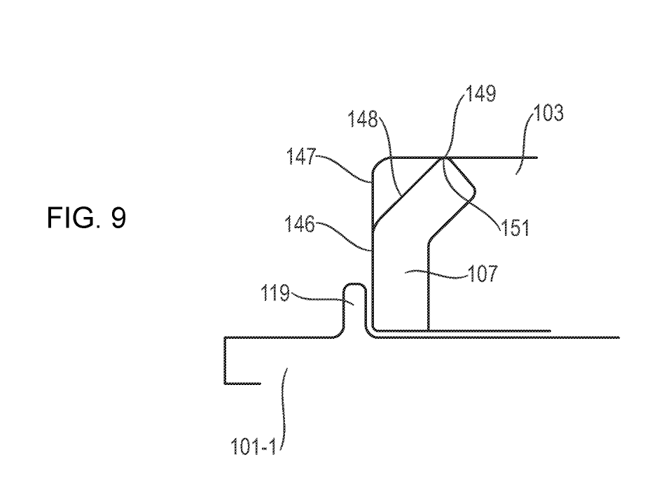

FIG. 9 shows a schematic view of a refrigerating device door with a door rack and a camera housing support;

FIG. 1 shows a refrigerator with an upper refrigerating device door 101-1 and a lower refrigerating device door 101-2 representative of a general refrigerating device 100. The refrigerator serves for instance to cool food and comprises a refrigerant circuit with an evaporator, a compressor, a condenser and a throttle organ. The evaporator is a heat exchanger, in which after expansion, the liquid refrigerant is evaporated by the heat absorption of the medium to be cooled, i.e. the air in the interior of the refrigerator.

The compressor is a mechanically operated component, which draws refrigerant vapor off the evaporator and discharges the same at a higher pressure to the condenser. The condenser is a heat exchanger, in which after compression the evaporated refrigerant is condensed by heat emission to an outer cooling medium, i.e. the ambient air. The throttle organ is an apparatus for constantly reducing the pressure by means of cross-section restriction.

The refrigerant is a fluid which is used to transfer the heat in the cold-generating system, which absorbs heat at low temperatures and at a low pressure of the fluid and outputs heat at a higher temperature and a higher pressure of the fluid, wherein changes of state of the fluid are usually included.

FIG. 2 shows a view of an inner surface of the refrigerating device door 101-1 with a door inner plate 115. Three door racks 103 are disposed on the inner surface of the refrigerating device door 101-1. The door racks 103 serve to secure the refrigerated product in the refrigerating device door 101-1, like for instance bottles. A camera housing support 107 is arranged laterally below the upper door rack 103. The camera housing support 107 comprises a camera module 105 encapsulated in a camera housing module. The camera module 105 is able to record an interior of the refrigerating device 100 in a pictorial manner.

The camera housing support 107 positions the camera housing module and thus the camera module 105 at the correct angle in the correct position in the interior of the refrigerating device 100. The camera housing support 107 can also ensure exchangeability of the camera housing module and conceal cables and terminals.

FIG. 3 shows a side view of a refrigerating device door 101-1 with the door rack 103 and the camera housing support 107. The camera housing support 107 is arranged in the side region and below the door rack 103.

The camera housing support 107 is arranged adjacently to the door rack 103. An outer surface 109 of the camera housing support 107 is aligned flush with the outer surface 111 of the door rack 103. The camera housing support 107 and the door rack 103 run along a contour line 139, which lies parallel to the refrigerating device door 101-1. The outer surface 111 formed by the door rack 103 is continued by an outer surface 109 of the camera housing support 107 at least in subareas. The camera housing support 107 runs with the shape of the door rack 103. The camera module 105 in the interior of the camera housing module 123 is arranged below the door rack 103 with a small gap for instance.

In order to receive and insert the camera housing module 123, the camera housing support 107 comprises a receiving facility 125, which comprises two opposing guide rails for inserting the camera housing module 123.

FIG. 4 shows a view of the refrigerating device door 101-1 with the door rack 103 and the camera housing support 107. Viewed from above, the contours of the door rack 101-1 and the camera housing support 107 are in part identical and have identically running sections. As a result, a shared contour is produced from the door rack 103 and camera housing support 107 along the contour lines 141 and 143.

The camera housing support 107 comprises a wall 131, the surface of which diagonally opposite a door inner plate 115 points into the interior of the refrigerating device 100, so that the inserted camera module 105 can record the interior of the refrigerating device 100 through the wall.

The side wall 113 of the door rack 103 and of the camera housing support 107 runs obliquely toward the door inner plate 115. A door pillar 119 is formed on the door inner plate 115. The camera housing support 107 is fastened to the door rack 103 or the door inner plate 115. For instance, the camera housing support 107 is screwed to the door inner plate 115. The camera housing support 107 is furthermore arranged adjacently to the door pillar 119.

The camera housing support 107 comprises an openable cover 121 for assembling the camera housing module 123, which is rotatably fastened to the camera housing support 107 and can be opened toward the center of the refrigerating device door 101-1. The cover 121 serves to provide access to the receiving facility 125 of the camera housing support 107 and to insert the camera housing module 125. The cover 121 fixes the camera housing module 125 and closes the camera housing support 107.

FIG. 5 shows a schematic view of the refrigerating device door 101-1 with the door rack 103 and the camera housing support 107. The door rack 103 has the contour line 147. The camera housing support 107 has the contour line 148. The contour line 147 and the contour line 148 comprise a shared contour section 146.

A further camera module 133 is arranged in a side wall 127 of the refrigerating device 100. The camera module 133 is arranged below a front edge of the lower shelf 145 in the side wall 127. The front edge of the lower shelf 145 runs parallel to the door rack 103. The camera housing support 107 protrudes into the interior of the refrigerating device 100 and comprises a recess 135 in the door region, into which the door pillar 119 is inserted. As a result, the camera housing support 107 on the refrigerating device door 101-1 can be displaced further outwards and the field of view of the camera module improves.

FIG. 6 shows a further schematic view of the refrigerating device door 101-1 with the door rack 103 and the camera housing support 107. The shared attachment or contour section 137 allows for a flush assembly of the door rack 103 of all varieties and the camera housing support 107. The shared contour section 129 at the top of the camera housing support 107 allows for use of the entire depth of the door rack 103 for the camera housing support 107. The door rack 103 has the contour line 147. The camera housing support 107 has the contour line 148. The contour line 147 and the contour line 148 have a shared contour section 146.

FIG. 7 shows a schematic view of the refrigerating device door 101-1 with the door rack 103 and the camera housing support 107. An adjustment tray 117 is attached to the sides of the camera housing support 107, said adjustment tray aligning the further regions of the contour of the camera housing support 107 with the contour of the door rack 103. The adjustment tray 117 serves to adjust the camera housing support 107 to the shape and the design of the door rack 107.

In order to be able to attach and lock the adjustment tray 117, an opening is formed laterally on the camera housing support 107, which serves to laterally fasten the adjustment tray 117. For this purpose, the adjustment tray 117 has a locking arm for instance, which engages in the opening of the camera housing support 107.

FIG. 8 shows a further schematic view of the refrigerating device door 101-1 with a door rack 103 and the camera housing support 107. The camera housing support 107 is fastened below the door rack 103 and has an angled shape in the cross-section. The door rack 103 runs obliquely in the direction of the refrigerating device door 101-1. The door rack 103 has the contour line 147. The camera housing support 107 has the contour line 148. The contour line 147 and the contour line 148 have a shared contour section 146 and a shared contour line 149 in the line of sight. The contour line 148 has a point of contact 151 with the contour line 149.

FIG. 9 shows a further schematic view of a refrigerating device door 101-1 with the door rack 103 and the camera housing support 107. The camera housing support 107 is fastened below the door rack 103. The door rack 103 runs at right angles in the direction of the refrigerating device door 101-1. The camera housing support 107 likewise forms a right angle with the refrigerating device door 101-1 before this bends. The door rack 103 has the contour line 147. The camera housing support 107 has the contour line 148. The contour line 147 and the contour line 148 have a shared contour section 146 and a shared contour line 149 in the line of sight. The contour line 148 has a point of contact 151 with the contour line 149.

The camera housing components are embodied such that they have identical design features to the refrigerator design parts. This relates to the contour of the parts and the coloring and the surface design, in particular the design with colored and partially transparent materials. The camera design adapts to the door design in terms of shape and color.

All features explained and shown in conjunction with individual embodiments of the invention can be provided in a different combination in the inventive subject material in order at the same time to realize their advantageous effects.

The scope of protection of the present invention is provided by the claims and is not restricted by the features explained in the description or shown in the Figures.

### LIST OF REFERENCE CHARACTERS

100 refrigerating device

101-1 refrigerating device door

101-2 refrigerating device door

103 door rack

105 camera module

107 camera housing support

109 outer surface

111 outer surface

113 side wall

115 door inner plate

117 adjustment tray

119 door pillar

121 cover

123 camera housing module

125 receiving facility

127 side wall

129 shared contour section

131 wall

133 camera module

135 recess

137 shared attachment section

139 contour line

141 contour line

143 contour line

145 lower shelf

146 shared contour section

147 contour line of the door rack

148 contour line of the camera housing support

149 shared contour line

151 point of contact

1-15. (canceled)

16. A refrigerating device, comprising:
a door rack having an outer surface;
a camera module; and
a camera housing support for positioning said camera module, said camera housing support disposed adjacent said door rack and said camera housing support having an outer surface at least partially flush with said outer surface of said door rack.

17. The refrigerating device according to claim 16, wherein said outer surface of said camera housing support continues from said outer surface of said door rack.

18. The refrigerating device according to claim 16, wherein said door rack has a side region in which said camera housing support is disposed.

19. The refrigerating device according to claim 16, wherein said door rack is configured to be located at a door rack position, and said camera housing support is disposed below said door rack or below said door rack position.

20. The refrigerating device according to claim 16, which further comprises:
a refrigerating device interior; and
an inner door plate;
said camera housing support having a wall with a surface running diagonally opposite to said inner door plate into said interior.

21. The refrigerating device according to claim 16, wherein said door rack and said camera housing support have a shared contour line.

22. The refrigerating device according to claim 16, which further comprises an inner door plate, said camera housing support being fastened to said door rack or to said inner door plate.

23. The refrigerating device according to claim 16, which further comprises an adjustment tray, said camera housing support having an opening for laterally attaching said adjustment tray.

24. The refrigerating device according to claim 16, which further comprises a door pillar, said camera housing support being disposed adjacent said door pillar.

25. The refrigerating device according to claim 16, which further comprises a camera housing module, said camera housing support having a cover configured to open for installation of said camera housing module.

26. The refrigerating device according to claim 25, wherein said cover is rotatably fastened to said camera housing support.

27. The refrigerating device according to claim 26, which further comprises a refrigerating device door having a center, said cover being oriented toward said center of said door.

28. The refrigerating device according to claim 16, wherein said camera housing support and said door rack have a shared contour line.

29. The refrigerating device according to claim 25, which further comprises a receiving facility having guide rails for inserting said camera housing module.

30. The refrigerating device according to claim 16, wherein said camera housing support is formed of transparent plastic.
